(19) United States
(12) Patent Application Publication
(10) Pub. No.: US 2023/0016735 A1
(43) Pub. Date: Jan. 19, 2023

(54) Computer, Diagnosis System, and Generation Method

(71) Applicant: Hitachi, Ltd., Tokyo (JP)

(72) Inventors: Hiroaki ITSUJI, Tokyo (JP); Takumi UEZONO, Tokyo (JP); Kenichi SHIMBO, Tokyo (JP); Tadanobu TOBA, Tokyo (JP)

(21) Appl. No.: 17/837,656

(22) Filed: Jun. 10, 2022

(30) Foreign Application Priority Data
Jul. 13, 2021 (JP) 2021-115823

(51) Int. Cl. G06F 11/22; G06F 11/07

(52) U.S. Cl. CPC G06F 11/2263; G06F 11/2273; G06F 11/0721

(57) ABSTRACT

Provided is a computer capable of reducing a diagnosis load. For each predetermined diagnosis target node among a plurality of nodes in a neural network, a determination processing unit calculates an expected output value expected as a calculation result of a node calculation process corresponding to the predetermined diagnosis target node, which is obtained when the node calculation process is executed using a predetermined input value. For each diagnosis target node, a generation processing unit generates as a diagnosis program a program for comparing the calculation result of the node calculation process corresponding to the diagnosis target node, which is obtained when the node calculation process is executed by an NN calculation processor using the input value, with the expected output value.

### BACKGROUND OF THE INVENTION

### 1. Field of the Invention

The present disclosure relates to a computer, a diagnosis system, and a diagnosis method.

### 2. Description of the Related Art

With the development of artificial intelligence (AI) technology, autonomous control of an edge device is progressing in fields such as autonomous driving and industrial infrastructure. In order to implement an AI function, a neural network, which is a mathematical model expressed by a combination of a plurality of nodes, is widely used. Hardware such as a graphics processing unit (GPU) or a dedicated large scale integration (LSI) is generally used as an accelerator for a calculation process defined in the neural network.

If the hardware as described above fails due to noise during operation, aged deterioration, or the like, an error may occur in the calculation process. Therefore, in order to ensure safety and implement a stable operation for a system including the edge device, diagnosis for the hardware is important.

Examples of diagnosis methods for diagnosing hardware include a method of multiplexing hardware and comparing calculation results obtained by the hardware, a method of comparing calculation results obtained in a plurality of times of a calculation process executed using the same hardware, a method of subjecting a calculation result to inverse calculation and checking whether original data is obtained, and a method of periodically inputting a diagnosis pattern to a diagnosis target circuit and comparing an output value of the diagnosis target circuit with an expected value (LBIST: Logic Built-In Self-Test).

WO2016/132468 (Patent Literature 1) discloses a diagnosis method of providing, to an identification neural network, a restoration neural network that performs inverse calculation. In this diagnosis method, it is determined whether input data restored using the restoration neural network is within a range learned in advance, and a determination result of the determination is used to evaluate a determination result of the identification neural network, thereby diagnosing the hardware.

In recent years, due to an increase in scale and complexity and the like of hardware to be diagnosed, an increase in diagnosis load such as a diagnosis time, power consumption, and a circuit area of a diagnosis circuit becomes a problem in a diagnosis method in the related art.

For example, in the diagnosis method of multiplexing the hardware, the scale of the hardware increases, and therefore, the power consumption and the circuit area increase. Therefore, in an edge device for which low power consumption, miniaturization, and the like are required, a desired specification may not be satisfied. Further, in LBIST, due to an increase in complexity of the diagnosis target circuit, the number of diagnosis patterns to be input is increased, and the diagnosis load such as the diagnosis time, the power consumption, and used memory capacity is increased.

In a technique described in Patent Literature 1, since a scale of a restoration neural network depends on a scale of an identification neural network, there is a problem that the diagnosis time, the power consumption, the circuit area, and the like increase due to an increase in the scale of the identification neural network.

### SUMMARY OF THE INVENTION

An object of the present invention is to provide a computer, a diagnosis system, and a generation method capable of reducing a diagnosis load.

A computer according to an aspect of the present disclosure generates a diagnostic program for diagnosing a processor. The processor executes a calculation process defined in a neural network. The computer includes: a determination processing unit configured to, for each predetermined diagnosis target node among a plurality of nodes in the neural network, calculate an expected value expected as a calculation result of a node calculation process corresponding to the predetermined diagnosis target node, which is obtained when the node calculation process is executed using a predetermined input value; and a generation processing unit configured to, for each diagnosis target node, generate as the diagnosis program a program for comparing the calculation result of the node calculation process corresponding to the predetermined diagnosis target node, which is obtained when the node calculation process is executed by the processor using the input value, with the expected value.

According to the invention, a diagnosis system and a diagnosis method capable of reducing a diagnosis load are provided.

### BRIEF DESCRIPTION OF THE DRAWINGS

FIG. 1 is a diagram illustrating a configuration of a diagnosis system according to a first embodiment.

FIG. 2 is a diagram illustrating an example of diagnosis sequence data.

FIG. 3 is a flowchart for illustrating an example of operations of the diagnosis system according to the first embodiment.

FIG. 4 is a diagram illustrating a configuration of a diagnosis system according to a second embodiment.

FIG. 5 is a diagram illustrating a configuration of a computer according to a third embodiment.

FIG. 6 is a diagram illustrating another example of parallel diagnosis sequence data.

FIG. 7 is a flowchart for illustrating an example of operations of a diagnosis system according to the third embodiment.

FIG. 8 is a diagram illustrating a configuration of a computer according to a fourth embodiment.

FIG. 9 is a diagram illustrating a configuration of a diagnosis system according to a fifth embodiment.

FIG. 10 is a diagram illustrating a hardware configuration of a computer according to a sixth embodiment.

### DESCRIPTION OF THE PREFERRED EMBODIMENTS

Hereinafter, embodiments of the present disclosure will be described with reference to the drawings. First Embodiment

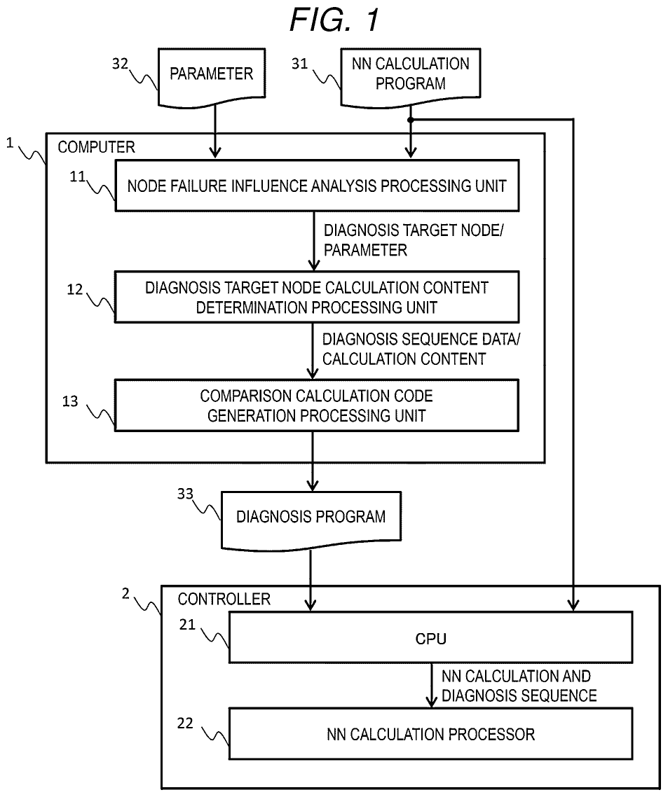

FIG. 1 is a diagram illustrating a configuration of a diagnosis system according to a first embodiment of the present disclosure. The diagnosis system illustrated in FIG. 1 diagnoses a neural network (NN) calculation processor 22 (described later) serving as hardware (a processor). The hardware executes an NN calculation process that is a calculation process defined in a trained NN. The diagnosis system includes a computer 1 and a controller 2. The computer 1 and the controller 2 are communicably connected to each other via, for example, a communication network (not shown).

The computer 1 is a generator that generates a diagnosis program 33 for diagnosing the NN calculation processor 22. Specifically, the diagnosis program 33 causes the NN calculation processor 22 to execute, for each predetermined diagnosis target node among nodes in the neural network, a diagnosis process for diagnosing whether a node calculation process corresponding to the predetermined diagnosis target node is normally performed.

An NN calculation program 31 for causing the NN calculation processor 22 to execute the NN calculation process, and a parameter 32 set for each node of a neural network to be diagnosed corresponding to the NN calculation process performed based on the NN calculation program 31 are input to the computer 1. The parameter 32 includes a weighting factor and a bias factor, which are set for each node. The computer 1 includes a node failure influence analysis processing unit 11, a diagnosis target node calculation content determination processing unit 12, and a comparison calculation code generation processing unit 13.

For each of a plurality of nodes in the neural network, the node failure influence analysis processing unit (hereinafter, abbreviated as an analysis processing unit) analyzes, based on the NN calculation program 31, a failure influence degree that is an influence degree of a hardware failure of the NN calculation processor 22 on a calculation result of the NN calculation process. The analysis processing unit 11 determines, based on the failure influence degree of each node, the diagnosis target node that is a node to be diagnosed among the nodes of the neural network.

Types of the hardware failure include, for example, a bit inversion failure in which a data value of a storage element is inverted due to noise or the like, a stack failure in which a data value of a storage element is fixed due to aged deterioration or the like, and permanent functional failure due to aged deterioration or the like. In the present embodiment, the influence degree does not depend on the type of the hardware failure.

In the analysis of the influence degree, the analysis processing unit 11 uses, for example, an error injection evaluation method to quantitatively analyze, as the failure influence degree, an influence degree of a calculation result of a node calculation process corresponding to each node with respect to a calculation result of the NN calculation process of the time when a hardware failure occurs. In the present embodiment, the analysis processing unit 11 calculates an index called architectural vulnerability factor (AVF) as the failure influence degree.

Here, the AVF is defined as an error rate for a calculation result of the neural network of the time when an all-failure mode occurs in a node. The all-failure mode is a mode in which all bits of an output value that is a calculation result of the node calculation process corresponding to the node are erroneous. The error rate of the calculation result of the neural network is a ratio of an error bit to all bits of the calculation result. An error of the bit means that a value of the bit is different from an expected value. For example, when the calculation result is 64 bits, 50 bits of the calculation result have values matching the expected value, and 14 bits of the calculation result have values different from the expected value, the AVF is 14/64.

In the determination of the diagnosis target node, for example, the analysis processing unit 11 may determine, as the diagnosis target node, a node having a failure influence degree equal to or greater than a threshold value, or may determine, as the diagnosis target node, a predetermined number of nodes from the node having the highest failure influence degree. For example, the number of the diagnosis target nodes is determined in advance according to a diagnosis time request value corresponding to a system using the NN calculation processor 22. The diagnosis time request value relates to a time that can be required for diagnosing the NN calculation processor 22.

For each diagnosis target node determined by the analysis processing unit 11, the diagnosis target node calculation content determination processing unit (hereinafter, abbreviated as a determination processing unit) 12 determines, based on the parameter 32, calculation content of a diagnosis process that is a calculation process for diagnosing the diagnosis target node.

The calculation content includes a type of the node calculation process corresponding to the diagnosis target node, an input value, an expected output value, and an output address of the node calculation process, and the like. A calculation type, which is the type of the node calculation process, is a type of calculation assigned to the node in the neural network. The calculation type includes convolution, pooling, activation, or the like in a case of a convolutional neural network (CNN), which is a representative neural network used for image recognition or the like. The input value is any fixed value set such that the output value does not overflow, and is determined in advance for each node, for example. In addition, there may be a plurality of input values. The expected output value is an expected value expected as an output value of a node calculation process using the input value when the node calculation process is executed. The expected output value is calculated by executing the node calculation process using the input value, for example. The node calculation process at this time is a process in which the weighting factor and the bias factor included in the parameter 32 are considered, and accordingly the node calculation process can be executed under a same condition as that of the NN calculation processing.

In the diagnosis process based on the diagnosis program 33, differently from a normal NN calculation process, the node calculation process of each node (diagnosis target node) is independent of the node calculation processes of the other nodes, and the calculation result of the node calculation process of each node does not depend on the calculation results of the node calculation processes of the other nodes. Therefore, in the diagnosis process, there is no restriction on a calculation order such as executing the node calculation process of the nodes in order from a previous layer of the neural network. Therefore, the determination processing unit 12 determines a diagnosis sequence, which is a diagnosis order of the diagnosis target node, according to a predetermined rule. For example, the determination processing unit 12 determines the diagnosis sequence in ascending order of node numbers set in advance for the nodes in the neural network.

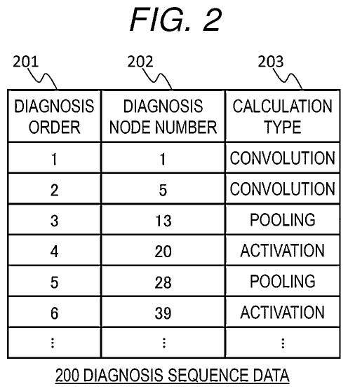

FIG. 2 is a diagram illustrating an example of diagnosis sequence data indicating a diagnosis sequence. Diagnosis sequence data 200 illustrated in FIG. 2 includes fields 201 to 203.

The field 201 stores the diagnosis orders. The field 202 stores diagnosis node numbers, which are node numbers of diagnosis target nodes. The field 203 stores the calculation types of the diagnosis target nodes.

Referring back to FIG. 1. For each diagnosis target node determined by the analysis processing unit 11, the comparison calculation code generation processing unit (hereinafter, abbreviated as a generation processing unit) generates, based on the calculation content and the diagnosis sequence determined by the determination processing unit 12, a code for comparing a calculation result, which is obtained by causing the NN calculation processor 22 to execute the node calculation process corresponding to the diagnosis target node using an input value included in the calculation content, with an expected output value included in the calculation content. The generation processing unit 13 generates a set of these codes as the diagnosis program 33. The diagnosis program 33 is programmed to store a comparison result at a specific address in a storage area of the controller 2. When there are a plurality of input values, the generation processing unit generates a code for comparing a calculation result with an expected output value for each of the input values.

The controller 2 is a control device that controls a predetermined controlled system, and includes a central processing unit (CPU) 21 and the NN calculation processor 22. The controlled system is, for example, an autonomous driving system of a vehicle. The CPU 21 and the NN calculation processor 22 cooperate to execute a control process for controlling the controlled system. The NN calculation process executed by the NN calculation processor 22 is a part of the control process.

The CPU 21 is a control processor that controls the NN calculation processor 22. The CPU 21 receives the NN calculation program 31 and the diagnosis program 33, and generates NN calculation and diagnosis sequence data for causing the NN calculation processor 22 to execute the NN calculation program 31 and the diagnosis program 33 in a predetermined order. The CPU 21 causes the NN calculation processor 22 to execute the NN calculation process and the diagnosis process by transmitting the NN calculation and diagnosis sequence data to the NN calculation processor 22. In the present embodiment, the CPU 21 generates the NN calculation and diagnosis sequence data so that the diagnosis process is executed after end of the NN calculation process.

The NN calculation processor 22 is hardware that executes the NN calculation process. The NN calculation processor 22 executes the NN calculation program 31 and the diagnosis program 33 based on the NN calculation and diagnosis sequence data received from the CPU 21 to execute the NN calculation process and the diagnosis process. In the present embodiment, the NN calculation processor 22 executes the diagnosis process in an idle time from the end of the NN calculation process to start of a next NN calculation process. In this case, the NN calculation process and the diagnosis process can be alternately executed.

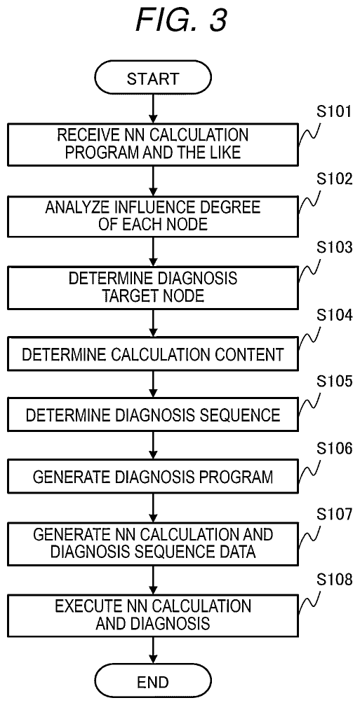

FIG. 3 is a flowchart for illustrating an example of operations of the diagnosis system according to the present embodiment.

First, the analysis processing unit 11 of the computer 1 receives the NN calculation program 31 and the parameter (step S101). For each node of a neural network, the analysis processing unit 11 analyzes, based on the NN calculation program 31, the failure influence degree that is the influence degree of the hardware failure of the NN calculation processor 22 on the calculation result of the NN calculation process (step S102). The analysis processing unit 11 determines, based on the failure influence degree of each node, the diagnosis target node from the nodes of the neural network to be diagnosed (step S103).

For each diagnosis target node determined by the analysis processing unit 11, the determination processing unit 12 determines, based on the parameter 32, the calculation content of the diagnosis process for diagnosing the diagnosis target node (step S104). Further, the determination processing unit 12 determines the diagnosis sequence according to the predetermined rule (step S105).

The generation processing unit 13 generates the diagnosis program 33 based on the calculation content and the diagnosis sequence determined by the determination processing unit 12, and transmits the diagnosis program 33 to the controller 2 (step S106).

The CPU 21 of the controller 2 receives the NN calculation program 31 and the diagnosis program 33, and generates the NN calculation and diagnosis sequence data for defining the order of executing the NN calculation program and the diagnosis program 33 (step S107). The NN calculation program 31 and the diagnosis program 33 are stored in, for example, a storage area (not shown) such as a memory provided in the controller 2.

The CPU 21 transmits the NN calculation and diagnosis sequence data to the NN calculation processor 22. The NN calculation processor 22 executes the NN calculation program 31 and the diagnosis program 33 based on the NN calculation and diagnosis sequence data received from the CPU 21 to execute the NN calculation process and the diagnosis process (step S108), and ends the process.

As described above, according to the present embodiment, for each predetermined diagnosis target node among the plurality of nodes in the neural network, the determination processing unit 12 calculates the expected output value expected as the calculation result of the node calculation process corresponding to the predetermined diagnosis target node, which is obtained when the node calculation process is executed using a predetermined input value. For each diagnosis target node, the generation processing unit 13 generates, as the diagnosis program 33, a program for comparing the calculation result of the node calculation process corresponding to the diagnosis target node, which is obtained when the node calculation process is executed by the NN calculation processor 22 using the predetermined input value, with the expected output value. Therefore, the process related to the diagnosis for the NN calculation processor 22 can be executed in a unit of the diagnosis target node, and thus the diagnosis for the NN calculation processor 22 can be executed without considering coupling between the nodes in the neural network. Therefore, a diagnosis load such as a diagnosis time can be reduced.

In the present embodiment, the expected output value is calculated based on the parameter 32 (specifically, the weighting factor and the bias factor) set for the diagnosis target node in the neural network. Therefore, the NN calculation processor 22 can be diagnosed by executing the node calculation process corresponding to the diagnosis target node under the same condition as that of the NN calculation process defined in the neural network, and thus the NN calculation processor 22 can be diagnosed more appropriately.

In addition, in the present embodiment, the diagnosis target node is determined based on the influence degree of the calculation result of the node calculation process corresponding to the node in the neural network on the calculation result of the NN calculation process. Therefore, a node having a high influence degree can be determined as the diagnosis target node, and thus the NN calculation processor 22 can be diagnosed more appropriately.

### Second Embodiment

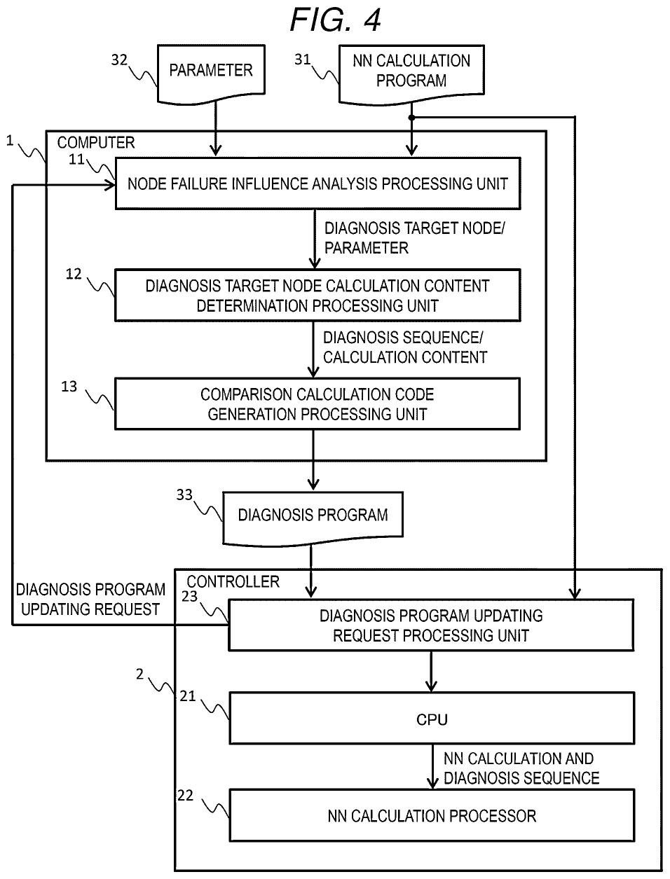

FIG. 4 is a diagram illustrating a configuration of a diagnosis system according to a second embodiment of the present disclosure. As compared with the diagnosis system according to the first embodiment illustrated in FIG. 1, the diagnosis system illustrated in FIG. 4 is different in that the controller 2 further includes a diagnosis program updating request processing unit 23.

The diagnosis program updating request processing unit 23 monitors whether the NN calculation program 31 is updated, and transmits a diagnosis program updating request for requesting update of the diagnosis program 33 to the analysis processing unit 11 of the computer 1 if the NN calculation program 31 is updated. The updated NN calculation program is stored in a storage area of the controller 2 and executed by the NN calculation processor 22.

When the computer 1 receives the diagnosis program updating request, the computer 1 executes the process according to the first embodiment that is described with reference to FIG. 3 and the like, and updates (regenerates) the diagnosis program 33.

According to the present embodiment, since the diagnosis program 33 is to be updated when the NN calculation program 31 is updated, appropriate diagnosis corresponding to a latest NN calculation program 31 can be executed.

The diagnosis program updating request processing unit 23 is provided separately from the CPU 21 in an example of FIG. 4, and may be implemented as a function of the CPU 21.

### Third Embodiment

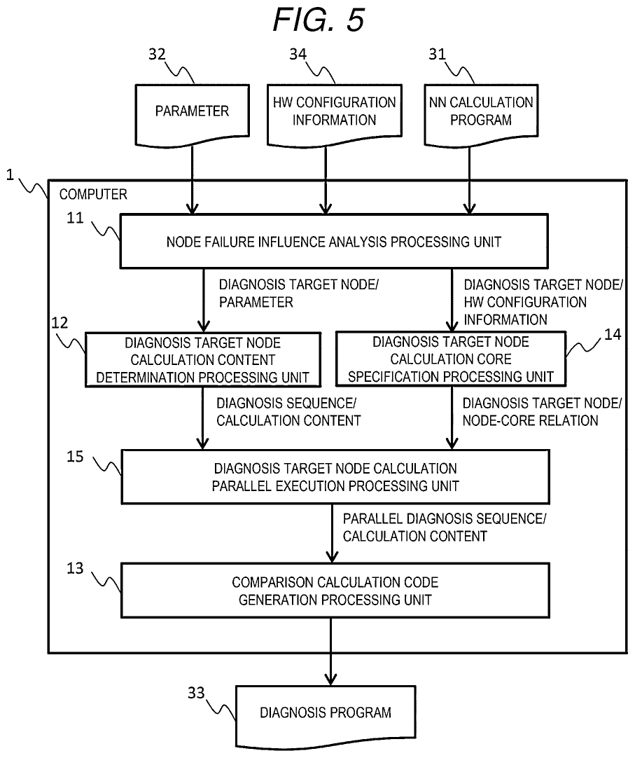

FIG. 5 is a diagram illustrating a configuration of the computer 1 according to a third embodiment of the present disclosure. As compared with the computer 1 according to the first embodiment illustrated in FIG. 1, the computer 1 illustrated in FIG. 5 is different by further including a diagnosis target node calculation core specification processing unit 14 and a diagnosis target node calculation parallel execution processing unit 15. The controller 2 has a configuration similar to that of the first embodiment, but a parallel calculation device represented by a GPU is used as the NN calculation processor 22. The parallel calculation device includes a plurality of calculation cores that are calculation resources for executing a calculation process, and the calculation cores can execute a plurality of calculation processes in parallel. The computer 1 further receives hardware (HW) configuration information 34 indicating a hardware configuration of the NN calculation processor 22. The HW configuration information 34 indicates, for example, the number of the calculation cores provided in the NN calculation processor 22.

For each diagnosis target node determined by the analysis processing unit 11, the diagnosis target node calculation core specification processing unit (hereinafter, abbreviated as a core specification processing unit) 14 specifies, based on the HW configuration information 34, a calculation core that executes a node calculation process corresponding to the diagnosis target node, and generates node-core relation data indicating a correspondence relation between the diagnosis target node and the calculation core that executes the node calculation process of the diagnosis target node.

The diagnosis target node calculation parallel execution processing unit (hereinafter, abbreviated as an execution processing unit) 15 specifies parallelizable processes, which are a plurality of processes executable in parallel by the NN calculation processor 22, among a plurality of node calculation processes corresponding to the diagnosis target nodes, based on the diagnosis target nodes determined by the analysis processing unit 11, the node-core relation data generated by the diagnosis target node calculation core specification processing unit 14, and calculation content and a diagnosis sequence determined by the determination processing unit 12. The execution processing unit 15 generates a parallel diagnosis sequence obtained by changing the diagnosis sequence so that the parallelizable processes are executed in parallel by the NN calculation processor 22.

In the diagnosis process, it is preferable to execute the node calculation process of each diagnosis target node under an operation condition similar to an operation condition in the NN calculation process. Therefore, in a parallelization process for specifying the parallelizable processes, the execution processing unit 15 specifies the parallelizable processes such that the node calculation process corresponding to the same node is executed by the same calculation core in the diagnosis process and the NN calculation process. In a general GPU, the plurality of calculation processes that are executable in parallel are only the same type of calculation process due to a hardware configuration, and therefore, the parallelizable processes include only the same type of calculation processes when the NN calculation processor 22 is the GPU.

The generation processing unit 13 generates the diagnosis program 33 based on the parallel diagnosis sequence generated by the execution processing unit 15 so that the plurality of the node calculation processes that are executable in parallel are executed in parallel.

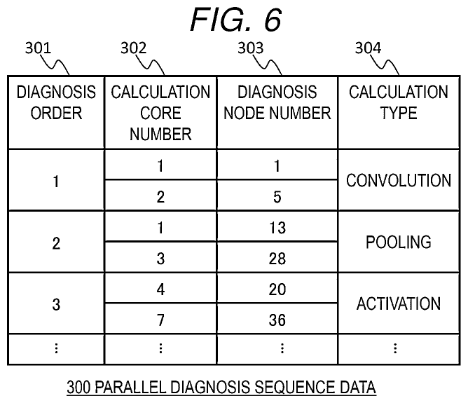

FIG. 6 is a diagram illustrating an example of parallel diagnosis sequence data indicating the parallel diagnosis sequence. Parallel diagnosis sequence data 300 illustrated in FIG. 6 includes fields 301 to 304.

The field 301 stores diagnosis orders. The field 302 stores calculation core numbers for identifying calculation cores that execute the node calculation processes of the diagnosis target nodes. The field 303 stores diagnosis node numbers of the diagnosis target nodes. The field 304 stores calculation types of the diagnosis target nodes. In an example of FIG. 6, the diagnosis node numbers of the diagnosis target nodes under the node calculation processes executed in parallel are assigned to a same diagnosis order.

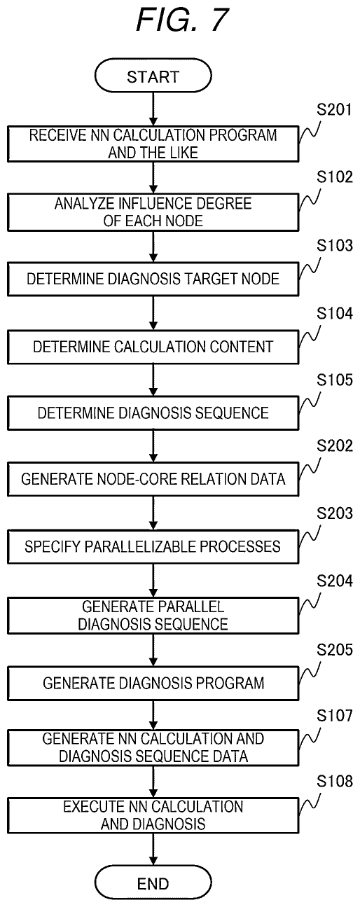

FIG. 7 is a flowchart for illustrating an example of operations of a diagnosis system according to the present embodiment.

First, the analysis processing unit 11 of the computer 1 receives the NN calculation program 31, the parameter 32, and the HW configuration information 34 (step S201). Thereafter, the processes of steps S102 to S105 described with reference to FIG. 3 are executed. Then, for each diagnosis target node determined by the analysis processing unit 11, the core specification processing unit 14 generates, based on the HW configuration information 34, the node-core relation data indicating the correspondence relation between the diagnosis target node and the calculation core that executes the node calculation process of the diagnosis target node (step S202).

The execution processing unit 15 specifies the parallelizable processes, which are a plurality of processes executable in parallel by the NN calculation processor 22, from among the plurality of node calculation processes corresponding to the diagnosis target nodes, based on the diagnosis target nodes determined by the analysis processing unit 11, the node-core relation data generated by the diagnosis target node calculation core specification processing unit 14, and the calculation content and the diagnosis sequence determined by the determination processing unit 12 (step S203).

The execution processing unit 15 generates, based on the parallelizable processes, the parallel diagnosis sequence obtained by changing the diagnosis sequence so that the parallelizable processes are executed in parallel by the NN calculation processor 22 (S204).

The generation processing unit 13 generates the diagnosis program 33 based on the calculation content determined by the determination processing unit 12 and the parallel diagnosis sequence generated by the execution processing unit 15, and transmits the diagnosis program 33 to the controller 2 (step S205). Then, same processes as the processes of steps S107 and S108 are executed, and then the process is ended.

According to the present embodiment, since the diagnosis program 33 is generated so that the plurality of the node calculation processes that are executable in parallel are executed in parallel, diagnosis of the NN calculation processor 22 can be executed at a higher speed.

### Fourth Embodiment

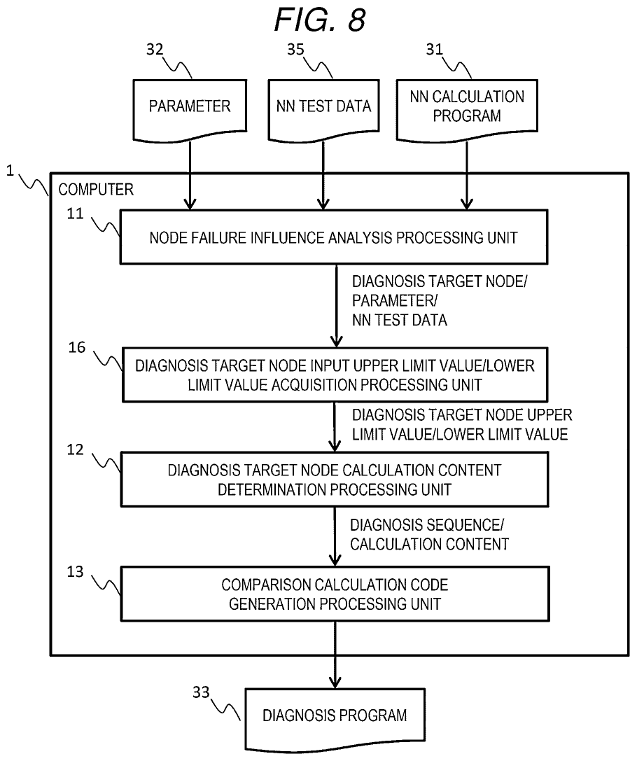

FIG. 8 is a diagram illustrating a configuration of the computer 1 according to a fourth embodiment of the present disclosure. As compared with the computer 1 according to the first embodiment illustrated in FIG. 1, the computer 1 illustrated in FIG. 8 is different by further including a diagnosis target node input upper limit value/lower limit value acquisition processing unit 16. The computer 1 further receives NN test data 35. The NN test data 35 is a plurality of pieces of input data for testing used in an NN calculation process. For example, when the NN calculation process is an image recognition process, the NN test data 35 is a plurality of pieces of image data.

The diagnosis target node input upper limit value/lower limit value acquisition processing unit (hereinafter, abbreviated as an acquisition processing unit) repeatedly executes the NN calculation process a plurality of times using each piece of the input data for testing included in the NN test data 35. The acquisition processing unit 16 acquires, based on execution results of the NN calculation processes, an upper limit value (maximum value) and a lower limit value (minimum value) from values input to diagnosis target nodes as an input upper limit value and an input lower limit value.

The determination processing unit 12 determines input values of a diagnosis process included in calculation content according to both the upper limit value and the lower limit value acquired by the acquisition processing unit 16.

According to the present embodiment, since the input value is automatically generated, time and effort for setting the input value can be reduced. Since an appropriate input value can be used, diagnosis for the NN calculation processor 22 can be performed more appropriately. In addition, since the upper limit value and the lower limit value of the NN calculation process, in which the test data 35 is used as an input value, are used, it is possible to diagnose whether the NN calculation process is normally executed in a range from the upper limit value to the lower limit value, and the diagnosis for the NN calculation processor 22 can be performed more appropriately.

### Fifth Embodiment

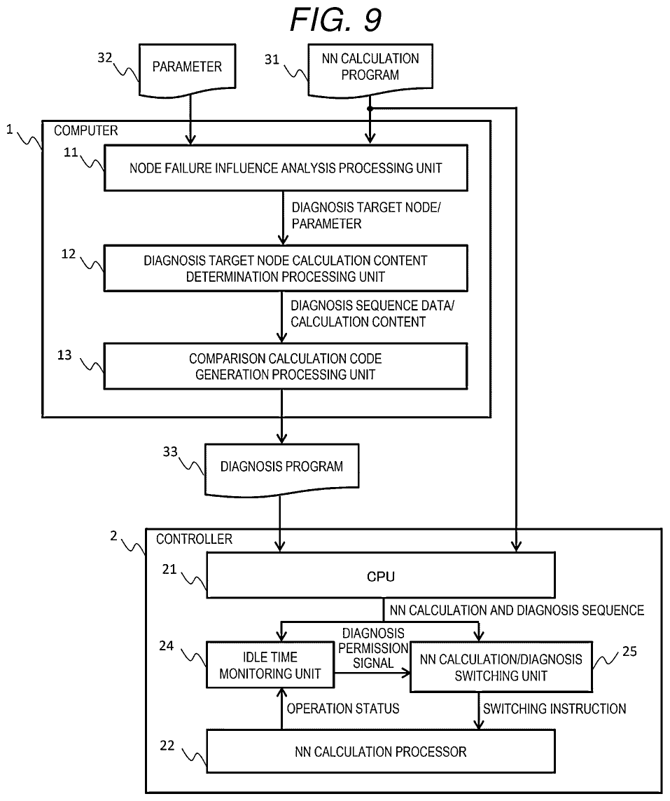

FIG. 9 is a diagram illustrating a configuration of a diagnosis system according to a fifth embodiment of the present disclosure. As compared with the diagnosis system according to the first embodiment illustrated in FIG. 1, the diagnosis system illustrated in FIG. 9 is different in that the controller 2 further includes an idle time monitoring unit 24 and an NN calculation/diagnosis switching unit 25.

The idle time monitoring unit 24 monitors an operation status of the NN calculation processor 22. For example, the idle time monitoring unit 24 monitors an idle time from end of an NN calculation process to start of a next NN calculation process, and predicts, based on a monitoring result, the idle time from the end of the NN calculation process to the start of the next NN calculation process as an estimated idle time. The idle time monitoring unit 24 compares the estimated idle time with a predetermined time (for example, a time required for a diagnosis process acquired by using a profiler of the NN calculation processor 22 or the like), and outputs a diagnosis permission signal indicating permission of execution of the diagnosis process when the estimated idle time is equal to or longer than the predetermined time.

The NN calculation/diagnosis switching unit 25 transmits a switching instruction to the NN calculation processor 22 based on the diagnosis permission signal received from the idle time monitoring unit 24, and switches a calculation process executed by the NN calculation processor 22 from the NN calculation process to the diagnosis process. Specifically, the NN calculation/diagnosis switching unit 25 switches the calculation process executed by the NN calculation processor 22 from the NN calculation process to the diagnosis process when receiving the diagnosis permission signal, and switches the calculation process executed by the NN calculation processor 22 from the diagnosis process to the NN calculation process when the diagnosis process is ended. Further, the NN calculation/diagnosis switching unit 25 may cause the NN calculation processor 22 to execute the diagnosis process again if a remaining time of the estimated idle time is equal to or longer than a required time after the diagnosis process is ended.

According to the present embodiment, it is not necessary to determine a calculation order for the NN calculation process and the diagnosis process in advance, and it is possible to implement a dynamic operation such as continuously executing the diagnosis process a plurality of times during a period in which the NN calculation process is not executed, instead of a static operation such as alternately executing the NN calculation process and the diagnosis process.

The idle time monitoring unit 24 and the NN calculation/diagnosis switching unit 25 are provided separately from the CPU 21 in an example of FIG. 9, and alternatively may be implemented as a function of the CPU 21.

### Sixth Embodiment

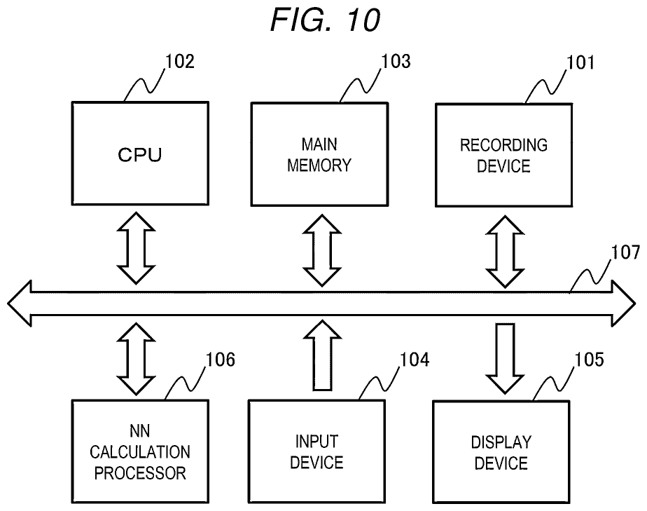

In the present embodiment, a hardware configuration of the computer 1 described in the first to fifth embodiments will be described. FIG. 10 is a diagram illustrating an example of the hardware configuration of the computer 1. As illustrated in FIG. 10, the computer 1 includes a recording device 101, a CPU 102, a main memory 103, an input device 104, a display device 105, and an NN calculation processor 106, which are connected via a bus 107.

The recording device 101 records data in a writable and readable manner. The recording device 101 records a program and the like for defining operations of the CPU 102 and the NN calculation processor 106. The CPU 102 reads the program recorded in the recording device 101 to the main memory 103, and implements a function corresponding to the program by using the main memory 103. Specifically, the CPU 102 implements the units 11 to 16 of the computer 1 by executing programs. The input device 104 receives various kinds of information from a user of the computer 1, an external apparatus (not shown), and the like, and the received information is used for processes of the CPU 102. For example, the NN calculation program 31, the parameter 32, the HW configuration information 34, the NN test data 35, and the like are recorded in the recording device 101 via the input device 104. The display device 105 displays various kinds of information.

The NN calculation processor 106 is a processor of a same type as the NN calculation processor 22 of the controller 2. For example, the NN calculation processor 106 executes an NN calculation process when the acquisition processing unit 16 illustrated in FIG. 8 acquires an input upper limit value and an input lower limit value. The NN calculation processor 106 may be omitted if the computer 1 does not execute the NN calculation process.

The controller 2 may also have a configuration similar to the configuration including the recording device 101, the main memory 103, the input device 104, and the display device 105 illustrated in FIG. 10. In this case, in the controller 2, a process result (comparison result) of the diagnosis process, the NN calculation program 31, and the diagnosis program 33 are stored in the recording device, the main memory, or the like.

The embodiments of the present disclosure described above are examples for the purpose of explaining the present disclosure, and the scope of the present disclosure is not intended to be limited only to those embodiments. A person skilled in the art could have implemented the present disclosure in various other embodiments without departing from the scope of the present disclosure.

What is claimed is:

1. A computer configured to generate a diagnosis program for diagnosing a processor, the processor being configured to execute a calculation process defined in a neural network, the computer comprising:
a determination processing unit configured to, for each predetermined diagnosis target node among a plurality of nodes in the neural network, calculate an expected value expected as a calculation result of a node calculation process corresponding to the predetermined diagnosis target node, which is obtained when the node calculation process is executed using a predetermined input value; and
a generation processing unit configured to, for each diagnosis target node, generate as the diagnosis program a program for comparing the calculation result of the node calculation process corresponding to the diagnosis target node, which is obtained when the node calculation processing is executed by the processor using the input value, with the expected value.

2. The computer according to claim 1, wherein
the determination processing unit is configured to calculate the expected value based on a parameter set for the diagnosis target node in the neural network.

3. The computer according to claim 2, wherein
the parameter includes a weighting factor and a bias factor.

4. The computer according to claim 1, further comprising:
an analysis processing unit configured to analyze, for each of the plurality of nodes, an influence degree of a calculation result of a node calculation process corresponding to the node on a calculation result of the calculation process, and determine the diagnosis target node from the plurality of nodes based on the influence degree.

5. The computer according to claim 1, wherein
the diagnosis program is generated when a program for causing the processor to execute the calculation process is updated.

6. The computer according to claim 1, wherein
the processor is configured to execute the calculation processing using a plurality of calculation cores,
the computer further comprises:
a specification processing unit configured to specify a correspondence relation between the diagnosis target node and the calculation core configured to execute the node calculation process corresponding to the diagnosis target node; and
an execution processing unit configured to specify, based on the correspondence relation, parallelizable processes that are the node calculation processes executable in parallel using the plurality of calculation cores, and
the generation processing unit is configured to generate the diagnosis program so that the parallelizable processes are executed in parallel by the processor.

7. The computer according to claim 1, further comprising:
an acquisition processing unit configured to acquire, as the input values, an upper limit value and a lower limit value from values input to the diagnosis target node when the calculation process is executed using a plurality pieces of test data.

8. A diagnosis system comprising the computer according to claim 1, and a controller including the processor and a control processor separate from the processor, wherein
the control processor is configured to cause the processor to execute the calculation process and a diagnosis process that is based on the diagnosis program.

9. The diagnosis system according to claim 8, wherein
the control processor is configured to monitor an operation status of the processor, predict an idle time from end of the calculation process to start of a next calculation process, and when the idle time is equal to or longer than a predetermined time, cause the processor to execute the diagnosis process.

10. A generation method to be implemented by a computer configured to generate a diagnosis program for diagnosing a processor, the processor being configured to execute a calculation process defined in a neural network, the generation method comprising:
for each predetermined diagnosis target node among a plurality of nodes in the neural network, calculating an expected value expected as a calculation result of a node calculation process corresponding to the predetermined diagnosis target node, which is obtained when the node calculation process is executed using a predetermined input value; and
for each diagnosis target node, generating as the diagnosis program a program for comparing the calculation result of the node calculation process corresponding to the diagnosis target node, which is obtained when the node calculation process is executed by the processor using the input value, with the expected value.
